(19) United States
(12) Patent Application Publication
(10) Pub. No.: US 2016/0358250 A1
(43) Pub. Date: Dec. 8, 2016

(54) DYNAMIC CREDIT LINE MANAGEMENT FOR PAYMENT ACCOUNTS

(71) Applicant: MasterCard International Incorporated, Purchase, NY (US)

(72) Inventors: Jennifer R. Dogin, Mamaroneck, NY (US); Sean Kirch, Mahwah, NJ (US)

(21) Appl. No.: 14/729,600

(22) Filed: Jun. 3, 2015

(51) Int. Cl. G06Q 40/02; H04L 29/08

(52) U.S. Cl. CPC G06Q 40/025; H04L 67/306

(57) ABSTRACT

A method includes establishing a credit account, setting a credit limit for the credit account, generating a payments profile for the holder of the credit account, and adjusting the credit limit based on the payments profile.

### BACKGROUND

Payment accounts such as credit card accounts, debit card accounts, and pre-paid card accounts are in widespread use. In one conventional manner of accessing a payment account, the account holder presents a plastic card at the point of sale in a retail store. The point of sale device reads account information from the card (e.g., via a magnetic stripe or through wireless communication with an integrated circuit in the card, or via electrical contacts on the card) and initiates a payment account system transaction using the information read by the card.

When the payment account is a credit card account, there is often a credit limit that the issuer of the account has established for the account. As is quite familiar, the credit limit typically represents the maximum amount of credit that the issuer wishes to advance to the account holder in connection with the account. If a purchase transaction requested for the account would exceed the amount of credit currently available under the credit limit, the issuer will ordinarily decline the requested transaction.

The present inventors have now recognized an opportunity for improvements in the manner of extending credit in connection with credit card accounts.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is a block diagram that illustrates a conventional payment system.

FIG. 2 is a block diagram that illustrates features of a payment system provided in accordance with aspects of the present invention.

FIG. 3 is a block diagram that illustrates a computer system that may be operated as part of the system of FIG. 2 and in accordance with aspects of the present invention.

FIG. 4 is a block diagram that illustrates another computer system that may be operated as part of the system of FIG. 2 and in accordance with aspects of the present invention.

FIG. 5 is a flow chart that illustrates a process that may be performed by the computer system of FIG. 3 in accordance with aspects of the present invention.

FIG. 6 is a flow chart that illustrates another process that may be performed by the computer system of FIG. 3 in accordance with aspects of the present invention.

FIG. 7 is a flow chart that illustrates a process that may be performed by the computer system of FIG. 4 in accordance with aspects of the present invention.

FIG. 8 is a flow chart that illustrates some details of the process of FIG. 7.

### DETAILED DESCRIPTION

In general, and for the purpose of introducing concepts of embodiments of the present invention, an issuer of a payment account may set up two or more different credit limits for a single credit card account. The credit limits may be applicable to different categories of requested purchase transactions. The different categories of requested purchase transactions may be defined in terms of categories of merchants involved in the purchase transactions.

This increased flexibility or granularity in the application of credit limits to credit card accounts, may help account holders in managing their spending. The setting of credit limits for various categories of purchases may come about as the result of exchanges of communications between the account holders and the account issuer. In general, credit limits may be managed cooperatively by the account holder and the account issuer in a dynamic manner. To give one specific example, an account holder who does not have a particularly good credit profile may be issued a credit card account with a rather low credit limit for general use of the account. However, there may be an additional, substantially higher credit limit applicable to certain categories of purchases (i.e., purchases from certain categories of merchants) that are important or essential for day-to-day living requirements. For example, the higher credit limit may apply to purchases from transit systems, gas stations, grocery stores and pharmacies.

In setting the two or more credit limits for a given account, the account issuer may consider a profile of the account holder's spending habits. This profile may be assembled from spending transactions that the account holder engages in from a number of different accounts, including, for example, all of the account holder's payment accounts (potentially across more than one account issuer) as well as checking accounts or other bank accounts (potentially across more than one financial institution). The account issuer's gathering of the spending habit information and generation of a payments profile for the account holder may be based on the account holder having opted in/consented to these activities by the account issuer.

The generation of the payments profile for the account holder may help guide the account issuer in its setting of two or more credit limits for the credit card account in question. The payments profile may be a useful supplement to the types of information available from credit reporting agencies. For example, it is typically the case that credit reporting agencies do not have information concerning the account holder's payment habits with respect to regularly occurring obligations such as rent payments and/or payments to child care providers. The payments profile for the account holder may allow the account issuer to conclude, in some cases, that the account holder demonstrates a high degree of reliability and responsibility with respect to the types of regularly occurring obligations just referred to. Consequently, the payments profile may allow the account issuer to conclude that the account holder is a better credit risk than his/her credit rating alone would indicate. This may aid the account holder in concluding that it is appropriate to set a higher credit limit for essential purchases than the general credit limit that would normally be indicated as appropriate based on the account holder's credit rating. With a higher credit limit for essential purchases, the credit card account may be more useful to the account holder as a source of credit when needed, while at the same time the credit limits are set by the account issuer in accordance with prudent business practices.

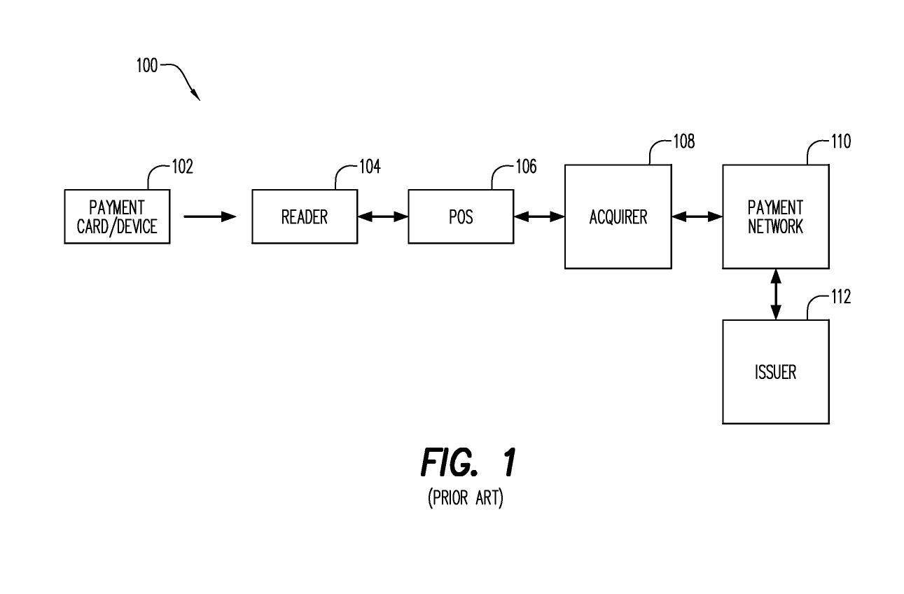

By way of background, a conventional payment system will first be briefly described. FIG. 1 is a block diagram that illustrates a conventional payment system 100.

The system 100 includes a conventional payment card/device 102. As is familiar to those who are skilled in the art, the payment card/device 102 may be a magnetic stripe card, an IC (integrated circuit) card, a fob, a payment-enabled smartphone, etc.

The system 100 further includes a reader component 104 associated with a POS terminal 106. In some known manner (depending on the type of the payment card/device 102) the reader component 104 is capable of reading the payment card account number and other information from the payment card/device 102.

The reader component 104 and the POS terminal 106 may be located at the premises of a retail store and operated by a sales associate of the retailer for the purpose of processing retail transactions. The payment card/device 102 is shown in FIG. 1 to be interacting with the reader component 104 and the POS terminal 106 for the purpose of executing such a transaction.

A computer 108 operated by an acquirer (acquiring financial institution) is also shown as part of the system 100 in FIG. 1. The acquirer computer 108 may operate in a conventional manner to receive an authorization request for the transaction from the POS terminal 106. The acquirer computer 108 may route the authorization request via a payment network 110 to the server computer 112 operated by the issuer of a payment card account that is associated with the payment card/device 102. As is also well known, the authorization response generated by the payment card issuer server computer 112 may be routed back to the POS terminal 106 via the payment network 110 and the acquirer computer 108.

One well known example of a payment network is referred to as the “Banknet” system, and is operated by MasterCard International Incorporated, which is the assignee hereof.

The payment card issuer server computer 112 may be operated by or on behalf of a financial institution (“FI”) that issues payment accounts to individual users. For example, the payment account issuer server computer 112 may perform such functions as (a) receiving and responding to requests for authorization of payment card account transactions to be charged to payment accounts issued by the FI; and (b) tracking and storing transactions and maintaining account records.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their POS terminals and associated proximity reader components. The system may also include a very large number of payment account holders, who carry payment cards or other devices for initiating payment transactions by presenting an associated payment account number to the reader component of a POS terminal.

In further aspects of the conventional payment system 100, not explicitly indicated in the drawing, the function of the POS terminal 106 may be performed by an unattended device, such as (a) a self-service gasoline pump that includes payment card reading capabilities, or (b) a transit system kiosk that issues or refills transit cards or similar devices while reading payment cards and initiating payment transaction authorization requests to obtain payment for the transit cards/refills.

Still further, and as is well-known, for e-commerce transactions, an e-commerce server computer (not shown) may function as the POS terminal. The e-commerce server computer may be operated by or on behalf of a merchant and may be accessed by the account holder via a browser program running on (for example) a personal computer (not shown) or a smartphone (not shown apart from payment device 102). To arrange for the payment portion of the e-commerce transaction, the account holder may manually enter a payment account number, or authorize a charge from a payment account number held on file by the merchant, or access a digital wallet, etc.

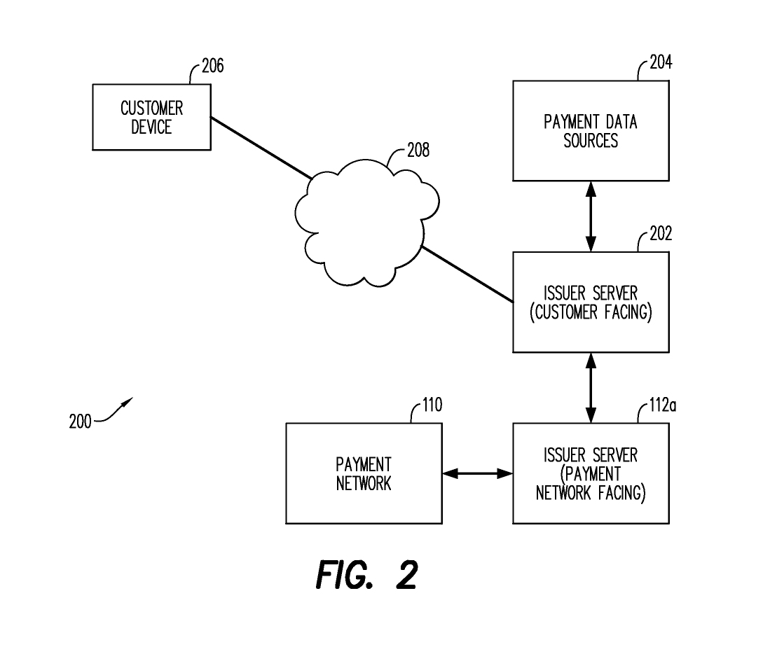

FIG. 2 is a block diagram that illustrates a payment system 200 provided in accordance with aspects of the present invention. (As was the case in FIG. 1, the payment system is depicted in FIG. 2 only in terms of components needed for a single transaction; in practice, the payment system 200 may include many more instances of at least some components.)

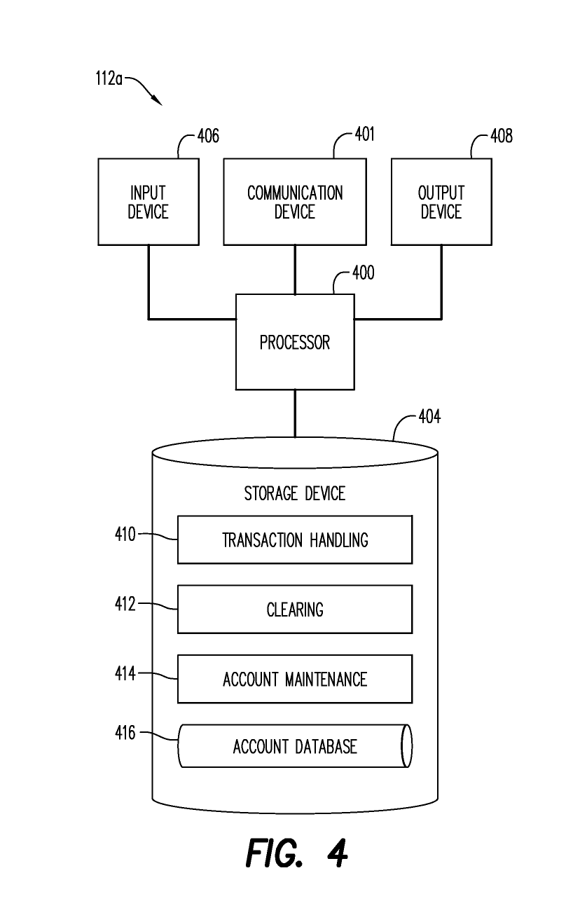

The payment system 200 includes the same type of payment network 110 referred to above in connection with FIG. 1. In addition, the payment system 200 includes an account issuer server computer 112a, which may provide all of the functionality of the conventional issuer server 112 referred to above in connection with FIG. 1. In addition to its conventional functionality, the account issuer server computer 112a may—in accordance with aspects of the present invention—store and apply two or more credit limits for at least some of the credit card accounts issued by the financial institution/account issuer that operates (or contracts for operation of) the account issuer server computer 112a. Further details of the account issuer server computer 112a and the functions it performs will be described below, including the discussion below of FIGS. 4, 7 and 8. Inasmuch as the account issuer server computer 112a exchanges data communications with the payment network 110, the account issuer server computer 112a may be considered to be “payment network facing”.

The payment system 200 may further include all of the other components that are shown in FIG. 1 (and discussed in connection with FIG. 1), but these components are not explicitly shown in FIG. 2 in order to simplify the drawing.

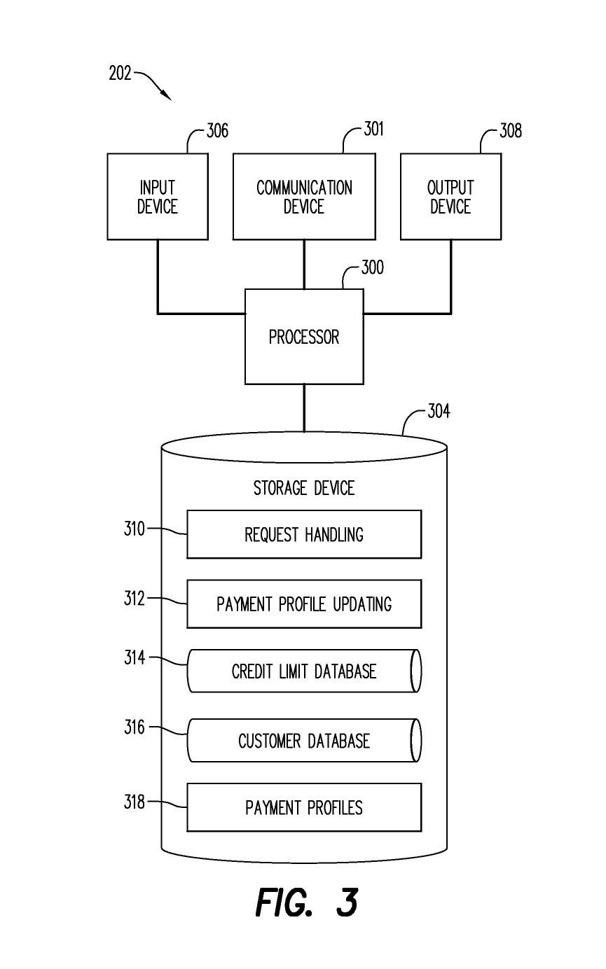

Continuing to refer to FIG. 2, the payment system 200 may also include a customer-facing account issuer computer 202. The customer-facing account issuer computer 202 may be provided in accordance with aspects of the present invention. Details of the customer-facing account issuer computer 202 will be described below, including in discussion of FIGS. 3, 5 and 6.

Also shown in FIG. 2 as block 204 are sources of data concerning payment activities by account holders or prospective account holders. The customer-facing account issuer computer 202 may be connected to the payments data sources 204 to obtain and/or to be fed data concerning the payment activities of the account holders/prospective account holders. In some embodiments, for example, the payments data sources 204 may include other financial institutions/payment account issuers. The data provided from the payment data sources 204 to the customer-facing account issuer computer 202 may include, for example, data that represents payment activities by account holders/prospective account holders who have opted in to a dynamic credit limit service offering from the account issuer that operates or sponsors the customer-facing account issuer computer 202. The types of payment activities reported by the payment data sources 204 may include payments by check and/or automatic payment transfers from deposit accounts, as well as payment account transactions. In some embodiments, the payment account issuer that operates or sponsors operation of the computers 202 and 112a may also maintain checking accounts or other deposit accounts for the account holders/prospective account holders who have opted in to the dynamic credit limit service offering. Accordingly, at least one of the payments data sources 204 may be another computer (not separately shown) operated by the credit card account issuer in addition to the computers 202 and 112a. That is, in generating a payments profile of a credit card account holder or prospective account holder, the account issuer may consider-among other data sources—records of checking account or other deposit account transactions for such accounts also issued by the account issuer.

FIG. 2 also shows a customer device 206 as part of the payment system 200. The customer device 206 may be operated by an account holder or prospective account holder to communicate with the customer-facing account issuer computer 202 via a communications network 208. The customer device 206 may, for example, be a typical personal computer or tablet computer that runs a browser program, or may be a mobile device that runs a mobile browser. In some cases where the customer device 206 is a payment-enabled smartphone or the like, it may be the same device as payment device 102 shown in FIG. 1.

Continuing to refer to FIG. 2, the communications network 208 may, for example, include the internet and possibly also one or more mobile communications networks.

FIG. 3 is a block diagram that illustrates an example embodiment of the customer-facing account issuer computer 202 as shown in FIG. 2 and provided in accordance with aspects of the present invention.

Referring now to FIG. 3, the customer-facing account issuer computer 202 may, in its hardware aspects, resemble a typical server computer, but may be controlled by software to cause it to function as described herein.

The customer-facing account issuer computer 202 may include a computer processor 300 operatively coupled to a communication device 301, a storage device 304, an input device 306 and an output device 308.

The computer processor 300 may be constituted by one or more processors. Processor 300 operates to execute processor-executable steps, contained in program instructions described below, so as to control the customer-facing account issuer computer 202 to provide desired functionality.

Communication device 301 may be used to facilitate communication with, for example, other devices (such as the account issuer server computer 112a, the payments data sources 204, the customer device 206, and numerous other customer devices). Communication device 301 may comprise numerous communication ports (not separately shown), to allow the customer-facing account issuer computer 202 to communicate simultaneously with a number of other computers and other devices, including communications as required to simultaneously handle numerous interactions with other devices referred to in connection with FIG. 2.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the customer-facing account issuer computer 202, executed by the processor 300 to cause the customer-facing account issuer computer 202 to function as described herein.

The programs may include one or more conventional operating systems (not shown) that control the processor 300 so as to manage and coordinate activities and sharing of resources in the customer-facing account issuer computer 202, and to serve as a host for application programs (described below) that run on the customer-facing account issuer computer 202.

The programs stored in the storage device 304 may also include a request handling application program 310 that controls the processor 300 to enable the customer-facing account issuer computer 202 to handle requests from account holders or prospective account holders. The requests may include, for example, (a) requests to enroll in dynamic credit line management services offered by the account issuer; and/or (b) requests for adjustments to one or more credit limits applicable to the account holder's credit card accounts; and/or (c) that one or more additional credit limits be established for a credit card account that already has one or more applicable credit limits.

The storage device 304 may also store a payments profile generation and/or updating application program 312 that controls the processor 300 to enable the customer-facing account issuer computer 202 to create, update and/or maintain payments profiles that summarize payment habits and/or payment-related activities of account holders and/or prospective account holders.

In addition, the storage device 304 may store a credit limit database 314. The credit limit database 314 may store credit limits that the customer-facing account issuer computer 202 has determined for credit card accounts issued by the account issuer. As will be understood from previous discussion, in at least some cases, for a given credit card account, the credit limit database may store more than one credit limit for the credit card account in question, with the different credit limits being applicable to different categories of requested payment transactions.

Still further, the storage device 304 may store a customer database 316. The customer database 318 may store data entries/partitions for the account holders and/or prospective account holders who have obtained or are seeking payment accounts from the account issuer.

Furthermore, the storage device 304 may store a payment profiles database 318. The payment profiles database 318 may store the payment profiles generated by the application program 312 referred to above.

The storage device 304 may also store, and the customer-facing account issuer computer 202 may also execute, other programs, which are not shown. For example, the customer-facing account issuer computer 202 may provide the functionality typically available from financial institution server computers that host online banking customer service functions for banking customers. In general, the programs and data resources required to provide this functionality are not explicitly shown in FIG. 3.

As another example of programs that may be stored in the storage device 304 and executed by the customer-facing account issuer computer 202 (but not shown in the drawing), there may be a reporting application, which may respond to requests from system administrators for reports on the activities performed by the customer-facing account issuer computer 202. The other programs may also include, e.g., one or more data communication programs, a database management program, device drivers, etc.

The storage device 304 may also store one or more additional databases (not shown) required for operation of the customer-facing account issuer computer 202.

FIG. 4 is a block diagram illustration of an embodiment of the account issuer server computer 112a.

The account issuer server computer 112a may have the same sort of hardware architecture as was described above in connection with the customer-facing account issuer computer 202. Thus, the account issuer server computer 112a may include, for example, a processor 400, a communication device 401, a storage device 404, an input device 406 and an output device 408. At least some of the components of account issuer server computer 112a may be in communication with each other. The components enumerated in this paragraph may resemble, in their hardware and functional aspects, the components of the customer-facing account issuer computer 202, as described above in connection with FIG. 3. However, the account issuer server computer 112a may be programmed in a different manner from the customer-facing account issuer computer 202 so that the former computer system provides different functionality from the latter computer system.

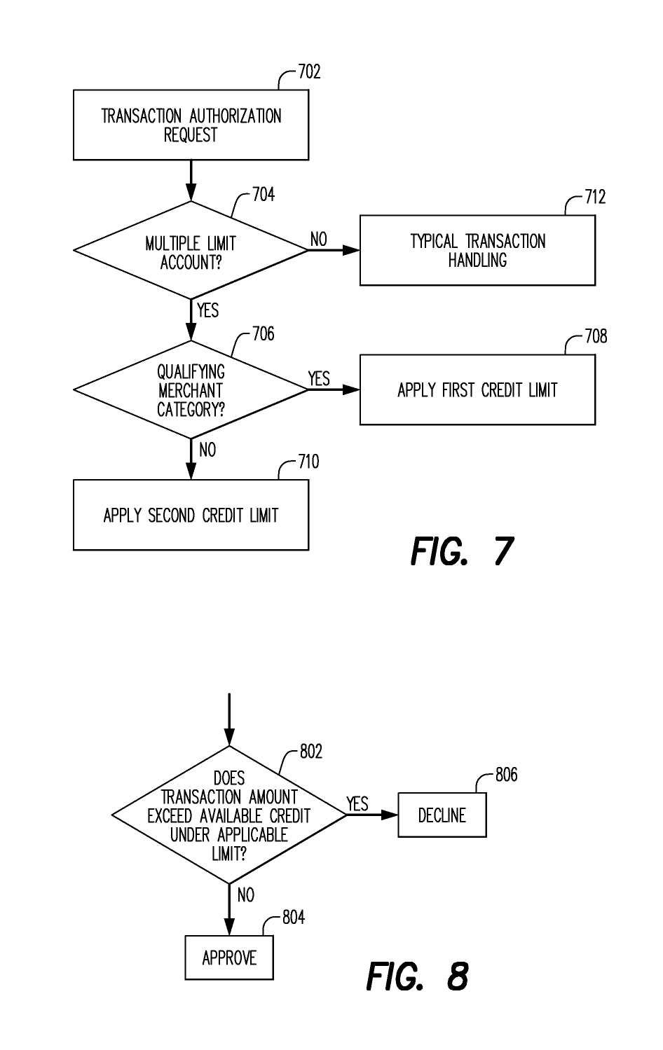

As noted above, the account issuer server computer 112a may provide all of the functionality of the issuer computer 112 shown in FIG. 1, including handling of transaction authorization request messages and generating responses to such messages. In addition, the account issuer server computer 112a may provide—in accordance with aspects of the present invention—functionality relating to credit card accounts for which two or more credit limits are applicable. Details of such functionality will be described below, including the discussion below of FIGS. 7 and 8.

In some embodiments, the credit limit database 312 (FIG. 3) stored in the customer-facing account issuer computer 202 may be shared with the account issuer server computer 112a and/or credit limit data from the credit limit database 312 may be loaded into the account issuer server computer 112a for use by the account issuer server computer 112a in responding to transaction authorization request messages.

The storage device 404 may store programs for controlling operation of the account issuer server computer 112a. These programs may include, for example, a transaction handling application program 410. The transaction handling application program 410 may generally operate in accordance with typical operating practices of issuer servers in a payment system as described in connection with FIG. 1. However, the transaction handling may be modified, in accordance with aspects of the present invention, so that the account issuer server computer 112a applies—for at least some credit card accounts—two or more credit limits that have been established for a respective account.

Another program that may be stored in the storage device 404 is a clearing operations application program 412. This program may in general operate in accordance with typical practices for clearing and settlement of payment account transactions.

The storage device 404 may further store an account maintenance application program 414 and an account database 416. The account maintenance application program 414 and the account database 416 may be provided so as to support application of plural credit limits for a given credit card account, in accordance with aspects of the present invention. For example, the account database 416 may store the credit limits determined, as described herein, by the customer-facing account issuer computer 202.

In the illustration of the payment system 200 as shown in FIG. 2, the account issuer server computer 112a and the customer-facing account issuer computer 202 are presented as two separate computers. In practice, however, there may be at least some overlap in the hardware and/or software resources making up those computers. Moreover, in some embodiments, the functionality ascribed herein to the account issuer server computer 112a and the customer-facing account issuer computer 202 may be distributed among three or more different computer systems.

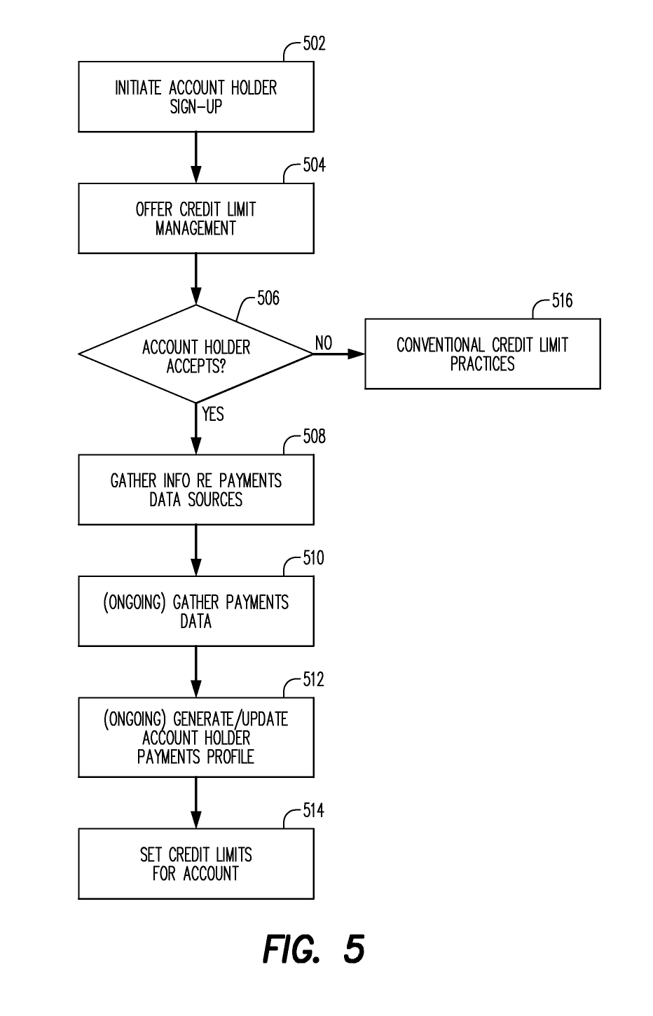

FIG. 5 is a flow chart that illustrates a process that may be performed by the customer-facing account issuer computer 202 in accordance with aspects of the present invention.

At 502 in FIG. 5, an individual may apply for a new credit card account with the account issuer that operates computers 112a and 202. For example, the individual (prospective account holder) may access a website through which the account issuer offers opportunities to apply for credit card products. For example, the website in question may be hosted by the customer-facing account issuer computer 202. As part of the application process, the prospective account holder may enter the types of information typically required in connection with such applications, including contact information, employment information and existing indebtedness.

For present purposes it will be assumed that the prospective account holder is creditworthy enough to be issued a credit card, but only one with a low credit limit, say $300. The customer-facing account issuer computer 202 may evaluate the prospective account holder's application and conclude that it should be accepted. The customer-facing account issuer computer 202 may so advise the (now) account holder, and then, at 504, the customer-facing account issuer computer 202 may indicate to the account holder that he/she has the opportunity to participate in a credit limit management/cash management service offering from the account issuer. For example, the customer-facing account issuer computer 202 may ask the account holder if he/she is willing to provide the account issuer with access to the account holder's payment activity records (for a past period of time and ongoing into the future) related to accounts other than the just-issued credit card account. The other accounts may include one or more other accounts maintained at the account issuer and/or at other financial institutions. The other accounts may be of various types, including other payment accounts (e.g., credit, debit, pre-paid), checking accounts, and other bank deposit accounts. In return for providing the account issuer with enhanced visibility into the account holder's payment habits, the account holder may receive an enhanced credit limit for the just-issued account, at least for some categories of transactions (e.g., for transactions with some categories of merchants). The establishment for a category-restricted additional credit limit in addition to (and in excess of) the general credit limit for the account may be dependent on analysis by the customer-facing account issuer computer 202 that indicates that the account holder is a good risk with respect to such a potential category-restricted credit limit, and the customer-facing account issuer computer 202 may so inform the account holder. The customer-facing account issuer computer 202 may also inform the account holder that the enhanced category-restricted credit limit may be a beneficial cash management tool for the account holder, and that the dual credit limit arrangement, if approved, may aid the account holder and account issuer to work together to see that the account holder's needs for credit are satisfied while operating within the account issuer's sound business practices.

A decision block 506 may follow block 504. At decision block 506, the customer-facing account issuer computer 202 may determine whether the account holder has indicated that he/she wishes to opt in to the credit limit management/cash management service offering.

If so, then block 508 may follow decision block 506. At block 508, the customer-facing account issuer computer 202 may prompt the account holder to enter information about the other payment accounts and/or bank accounts owned by the account holder. This information may identify the relevant financial institution, indicate the account type and account number, and also may include the account holder's consent to the account issuer's access to payment records related to the other accounts.

At 510, the customer-facing account issuer computer 202 may gather payments data related to the other account holder accounts identified at 508. For example, the customer-facing account issuer computer 202 may seek and obtain from other relevant financial institutions records of transactions in which the account holder made payments from the identified accounts. This may include the account issuer referencing records of other accounts it has issued to the account holder in addition to the credit card account that has just been issued. The payment records may include date and amount of payment (including transactions honoring checks written by the account holder); for some or all of the transactions reflected by the payment records some information about the payment recipient may be included, such as name of recipient, merchant category, etc. In addition to seeking and obtaining past payment records, the customer-facing account issuer computer 202 may seek and obtain ongoing updates regarding payments made by the account holder from the other accounts.

At 512, the customer-facing account issuer computer 202 may construct a payments profile for the account holder. The payments profile may reflect some or all of the payments data concerning the account holder that was collected by the customer-facing account issuer computer 202 at step 510. Thus, for example, the payment profile may reflect information about the account holder's payment habits and practices, including regular (or late or irregular) payments from deposit accounts such as checking accounts. In some cases and/or in some embodiments, the payments profile may include one or more inferences made by the customer-facing account issuer computer 202 about the account holder's payment habits based on the payments data collected about him/her by the customer-facing account issuer computer 202. For example, if the payment data indicates that a check in the amount of $800 is paid from the account holder's checking account early in each calendar month, the customer-facing account issuer computer 202 may infer that this payment is a rent check. This inference may be supported by additional information about the account holder, such as information indicating that the account holder is not a homeowner. Other information that may support this inference may include (if known) the name of the payee of the checks, which may identify the payee as a real estate management company. Moreover, further data that may support such an inference may be a pattern in which the amount of the monthly check was increased annually over the past few years by, say, five to ten percent.

Having inferred that the monthly check for $800 was a rent check, the customer-facing account issuer computer 202 may further examine the regularity with which the checks in this amount were paid from the account holder's checking account. If there was a high degree of regularity, the customer-facing account issuer computer 202 may infer that the account holder has had financially responsible payment habits as a tenant, and this inference may be included in the payments profile for the account holder.

Similar inferences may be made with respect to the account holder's payment habits with respect to other regular financial obligations paid by check, such as day care or elder care. With inferences of this kind, including inferences about the account holder's financial responsibility as a credit risk, the account issuer may have insight into the creditworthiness of the account holder that goes beyond information available to and through credit rating agencies. For example, even if the account holder's checking account typically comes close to being depleted at the end of each month or pay period, the account issuer may conclude from the account holder's regular and consistent meeting of his/her financial obligations that he/she is a better credit risk than his/her net worth alone may indicate.

By the same token, if the payment data gathered at step 510 indicates some irregularity or inconsistency in the account holder's payment habits, the customer-facing account issuer computer 202 may draw one or more adverse inferences about the account holder's financial responsibility. Again, this may reflect information not available to or through a credit rating agency.

In some embodiments, the customer-facing account issuer computer 202 may be programmed with a model for analyzing all financial information available about the account holder, including credit history as well as payments data gathered at step 510. As an output of the model, the customer-facing account issuer computer 202 may provide one or more categorizations of the account holder, and/or one or more scores for the account holder, and/or one or more determinations regarding an amount of credit to be extended to the account holder, including for example one or more category-restricted credit limits to be extended to the account holder in addition to the general credit limit that has been assigned to the account holder's credit card account. Some or all of this information/output results may be included in the payments profile for the account holder as generated at 512.

Setting of the above-mentioned additional category-restricted credit limit or limits by the customer-facing account issuer computer 202 is indicated at block 514, which may also include the definitive setting of the general credit limit for the account holder's credit card account. To give one specific example, for a given account holder the general credit limit may be quite low, say $300, but there may be an additional credit limit of $750 that is also applicable to the credit card account but only for purchases from certain categories of merchants; in particular for this example it is assumed that the latter categories of merchants consist of transit companies, gas stations, grocery stores and pharmacies. The customer-facing account issuer computer 202 may have established this additional category-restricted credit limit so that the account holder has credit resources available for basic living needs, such as food, prescription drugs, and commuting expenses. The customer-facing account issuer computer 202 may have established this additional credit facility for the account holder based on favorable inferences about the account holder's payment habits even though the account holder's credit rating alone may not have justified the additional credit facility. In this way, the usefulness of the credit card account to the account holder is increased, while at the same time, the account issuer has engaged in risk management such that the risks involved in extending the additional credit facility have been analyzed and found to be acceptable.

In conjunction with step 514, the customer-facing account issuer computer 202 may share the credit limits that it set with account issuer server computer 112a for use by the account issuer server computer 112a in approving or declining transaction authorization requests related to the credit card account.

In addition to the initial gathering and analysis of the payments data for the account holder, the customer-facing account issuer computer 202 may regularly/periodically update the data gathering and analysis represented by steps 510 and 512 and as appropriate may update the credit limits for the credit card account based on the updated payments profile for the account holder. Accordingly, the customer-facing account issuer computer 202 may subsequently increase or decrease one or more of the credit limits for the credit card account, including one or more category-restricted credit limits, based on observed changes in the account holder's payment habits, ongoing experience with the account holder, etc.

Referring again to decision block 506, if the customer-facing account issuer computer 202 determines that the account holder has not opted in to the credit limit management/cash management service offering, then block 516 may follow decision block 506. At block 516, the customer-facing account issuer computer 202 may set up and administer the new credit card account without the processing described above with respect to steps 508-514.

At an early stage of the discussion of FIG. 5, it was assumed that the account holder/prospective account holder had accessed a website hosted by the customer-facing account issuer computer 202. However, the account holder/prospective account holder may alternatively have contacted the account issuer in some other manner, such as through a call center managed by or for the account issuer.

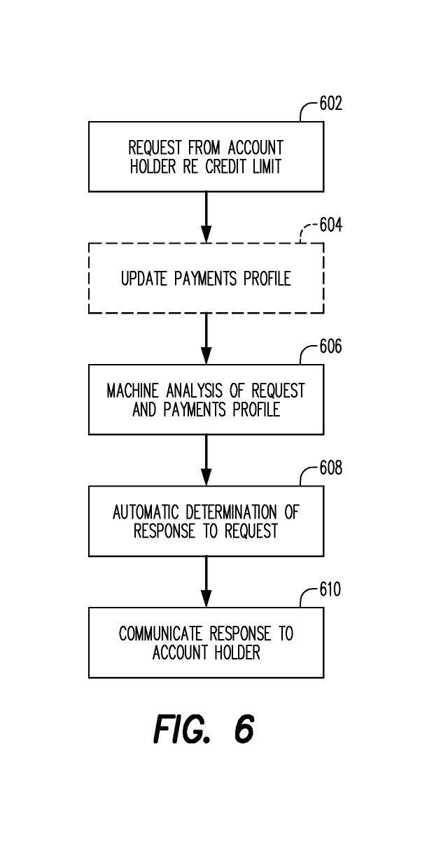

FIG. 6 is a flow chart that illustrates another process that may be performed by the customer-facing account issuer computer 202 in accordance with aspects of the present invention. It will be assumed for purposes of the process of FIG. 6 that a particular account holder already has had a credit card account issued to him/her by the account issuer and that a general credit limit has been established for the credit card account; it may or may not be the case that one or more category-restricted credit limits have also been established for the credit card account.

At 602 in FIG. 6, the customer-facing account issuer computer 202 may receive a request from an account holder regarding the credit limit(s) that are applicable to the account holder's credit card account. For a specific example, assume that the general credit limit for the account is $1,000, but the account holder wishes to take a vacation and so is requesting a temporary increase in the credit limit with respect to merchants in the travel and entertainment categories.

At 604, the customer-facing account issuer computer 202 may, if necessary, update the payments profile for the account holder who made the request at step 602. In other embodiments, the payments profile for the account holder may already be current or may be updated at frequent intervals, so that step 604 may not be implemented.

At 606, the customer-facing account issuer computer 202 may perform an analysis of the account holder's request using machine intelligence techniques. The analysis may consider specifics of the request in conjunction with the payments profile for the account holder. Based on the analysis, and as indicated at 608 in FIG. 6, the customer-facing account issuer computer 202 may automatically determine a response to the account holder's request. At 610, the customer-facing account issuer computer 202 may communicate the response to the account holder.

Returning to the specific example assumed for this discussion of FIG. 6, the outcome of steps 606-610 may be that the customer-facing account issuer computer 202 concludes that the account holder has exhibited financial responsibility over the past few years, and that the account holder's request entails no more than an acceptable risk. Accordingly, the customer-facing account issuer computer 202 may establish a temporary additional credit limit of $2,000, restricted to merchants in the travel and entertainment categories. At the same time, in some embodiments, the model used by the customer-facing account issuer computer 202 to evaluate the account holder's request may indicate that it would be advisable to restrict the account holder's general spending on the vacation (to avoid excessive spending on souvenirs, clothing or the like). For that reason, the customer-facing account issuer computer 202 may add a further temporary category-restricted credit limit on the credit card account to reduce the available credit limit to $500 with respect to merchant categories that could otherwise involve a shopping spree during the vacation.

As before, the customer-facing account issuer computer 202 may share with the account issuer server computer 112a any changes in credit limits determined by the customer-facing account issuer computer 202, so that the account issuer server computer 112a can apply the updated or additional credit limits in approving or declining transaction authorization requests for the credit card account.

FIG. 7 is a flow chart that illustrates a process that may be performed by the account issuer server computer 112a in accordance with aspects of the present invention.

At 702 in FIG. 7, the account issuer server computer 112a may receive a typical transaction authorization request message. Among other data, the message may include an account identifier (primary account number—also known as a “PAN”—or a payment token that the account issuer server computer 112a is able to translate into a PAN for the payment account in question), transaction amount, and data that identifies the merchant by category. For present purposes, it is assumed that the payment account identified in the authorization request message corresponds to a credit card account. Based on that assumption, a decision block 704 may follow block 702. At decision block 704, the account issuer server computer 112a looks up data for the indicated credit card account to determine whether there is more than one credit limit applicable to the credit card account.

If a positive determination is made at decision block 704 (i.e., if the account issuer server computer 112a determines that more than one credit limit is applicable), then decision block 706 may follow decision block 704. For purposes of discussing decision block 706 and its branches, it will now be assumed that two and only two credit limits are applicable to the credit card account in question. A first one of the credit limits may be category-restricted in that it applies to all transactions for merchants in certain categories. (For example, in accordance with an illustrative example described above, the merchant categories included could consist of transit systems, gas stations, grocery stores and pharmacies.) The second credit limit may be a general credit limit—i.e., applicable to all transactions not governed by the first credit limit.

Referring again to decision block 706, at that decision block the account issuer server computer 112a may determine whether the merchant category for the current authorization request indicates that the transaction qualifies for consideration under the first (category-restricted) credit limit. If so, then block 708 may follow decision block 706. At block 708, the first credit limit is selected to be applied to the current authorization request.

Referring again to decision block 706, if a negative determination is made at that decision block (i.e., if the account issuer server computer 112a determines that the merchant category data in the authorization request does not indicate that the transaction qualifies for consideration under the category-restricted credit limit), then block 710 may follow block 708. At block 710 the second (i.e., general) credit limit is selected for application to the current authorization request.

FIG. 8 is a flow chart that shows details of the processing in block 708 or block 710, as the case may be. At decision block 802 in FIG. 8, the account issuer server computer 112a may determine whether—given the particular credit limit selected for application—the available credit for the credit card account is sufficient in view of the transaction amount. In other words, it may be determined whether the transaction amount exceeds the available credit under the applicable credit limit. If not, then the account issuer server computer 112a may approve the transaction (block 804). Otherwise, the account issuer server computer 112a may decline the transaction (block 806).

(Those who are skilled in the art will recognize that, in practical implementations of the invention, the account issuer server computer 112a may take other or further steps in addition to comparing the transaction amount with the available credit under the applicable credit limit. For example, the account issuer server computer 112a may also check that the credit card account is in good standing, that there is no alert in effect for the account, that risk management procedures are completed successfully, and may perform other typical functions performed by an issuer computer in handling a transaction authorization request message.)

Referring again to decision block 704 in FIG. 7, if a negative determination is made at that point (i.e., if the account issuer server computer 112a determines that only one credit limit is associated with the credit card account identified by the authorization request), then block 712 may follow decision block 704. At block 712, the account issuer server computer 112a may handle the authorization request in the typical way that issuer servers handle authorization requests for the conventional situation in which only one credit limit is associated with a credit card account.

Referring again to block 708, which was assumed to be the branch from decision block 706 which selects a category-restricted credit limit, it should be noted that, in some cases, the category-limited credit limit may be lower than the general credit limit. For example, it might be found advisable in some cases to have quite a low credit limit, say $100, for transactions at liquor stores, even for a credit card account with a higher general credit limit such as $500 or $1,000. In some embodiments, e.g., for young adults who are first-time credit card account holders, the account holder might suggest such a low category-restricted credit limit as a cash management tool to help guide the account holder to good spending habits, and the account holder may voluntarily opt in to that suggestion. The same sort of lower category-restricted credit limit may, for example, also or alternatively be established for other merchant categories, such as restaurants and/or bars.

The process of FIG. 7 was set forth on the assumption that no more than two credit limits were associated with the credit card account in question. However, as was seen from other scenarios previously described herein, in some cases there could be three or more credit limits associated with a single credit card account. Those who are skilled in the art can readily adapt the example given in FIG. 7 to such cases.

Moreover, in the example illustrated in FIG. 7, the credit limit other than the general credit limit was assumed to be category-restricted. However, in accordance with other embodiments, a credit card account may have two or more credit limits, where at least one of the credit limits is neither general nor category-restricted. For example, in some embodiments a credit card account may have a general credit limit as well as another credit limit (e.g., a higher limit) that is applicable to transactions at a single particular merchant.

In another embodiment, in addition to a general credit limit, there may be a per-transaction limit (i.e., large transaction amount limit) that is lower than the general credit limit.

In another embodiment, there may be a general credit limit and another credit limit that only applies to e-commerce transactions (or only applies to in-store transactions).

In some embodiments, the transaction authorization request message may identify the item or items purchased, and the account issuer may add to at least some credit card accounts an additional credit limit that only applies to one or more types of purchased items. In other words, in addition to or instead of credit limits that are granular with respect to merchant categories, there may be credit limits that are granular as to type or types of items purchased.

Referring again to block 602 in FIG. 6, the account holder may submit his/her request to the customer-facing account issuer computer 202 in a number of different ways, such as accessing a website hosted by the customer-facing account issuer computer 202, via a call center, etc. It may be the case, even when the account holder submits his/her request and receives a response to the request by speaking with a human operator at a call center, that the determination of a response to the request is made entirely automatically by the customer-facing account issuer computer 202, communicated to the operator by a work station (not shown) connected to the customer-facing account issuer computer 202, and communicated orally over the phone to the account holder by the operator.

In some embodiments, the customer-facing account issuer computer 202 may analyze the account holder's spending transactions to detect events that suggest that a (possibly temporary) category-restricted credit limit should be added to an existing credit card account. The customer-facing account issuer computer 202 may then implement the indicated additional credit limit and then inform the account holder.

For example, the customer-facing account issuer computer 202 may recognize that the account holder has made payments to a hospital and started making purchases at a merchant that sells products for use with very young children. The customer-facing account issuer computer 202 may then infer that the account holder has had a baby. As a result, the customer-facing account issuer computer 202 may add a category-restricted credit limit—higher than the general credit limit—to the account holder's credit card account, where the qualifying merchant categories are of the type that supply the needs of new parents. In some embodiments, in the same situation, other category-restricted credit limits may be added to limit spending of other kinds (i.e., freezing/cutting down other spending categories) to help insure that the account holder does not get over-extended.

Other types of events that the customer-facing account issuer computer 202 may detect may include a change of address, a purchase of a home, a relocation to a different city, purchase of a motor vehicle, etc.

In some embodiments, the customer-facing account issuer computer 202 may only add a category-restricted credit line, whether higher or lower than a general credit line, if the account holder expressly consents. In such cases, the category-restricted credit limit(s) may be both a budgeting tool for the account holder and a risk management measure for the account issuer. In other embodiments, the account holder may make addition of such a credit limit mandatory. The latter may be appropriate, for example, for an account holder who is being extended credit after a recent bankruptcy. In some embodiments, the account holder may more readily issue a credit card account to an individual who has recently gone bankrupt when an analysis of the individual's spending habits indicates that the bankruptcy was due to large medical expenses and the individual generally showed responsible spending habits apart from the financial setback due to illness or injury. In the case of an individual who was recently bankrupt, the entire credit card account may be category-restricted in some embodiments, such that it can be used only for spending on staple items. An account of this kind may allow the account holder to build his/her credit standing more rapidly than with conventional approaches, in which no credit would be extended to the individual for a considerable time after bankruptcy.

Dynamic credit line management practices, including having two or more credit limits applicable to a given credit card account, may be particularly helpful for individuals who are relatively new to managing credit obligations and other financial matters. Such individuals may include, for example, young adults who are just establishing their financial independence. Other individuals in this category may include individuals who have recently divorced or been widowed and who did not previously bear much responsibility for financial matters. Students who have some earnings income could also benefit by having a very low general credit limit, but a higher category-restricted limit for groceries, bookstores and transit systems (or a similar array of merchant categories).

In cases where a given credit card account has two or more applicable credit limits, as described herein, the account issuer server computer 112a and/or the customer-facing account issuer computer 202 may set up one or more rules or protocols governing the order and/or proportions according to which payments made by the account holder to the account issuer against the overall outstanding credit card account balance may be credited/applied to increase the available credit amount under the various credit limits. Printed or electronic account statements, whether periodic or continually updated, as rendered to the account holder by the account issuer, may indicate available credit amounts under each of the credit limits applicable to the credit card account. In some embodiments, the credit customer/account holder may be permitted to request or set up the percentages for application of payments to the amounts due under the respective credit limits. In some embodiments, this may be done virtually in real time and/or in conjunction with making payments on the account. In this way, for example, the account holder may, in a situation where he/she anticipates need of more available credit under a certain limit (e.g., for a certain category of transaction) in a particular month, the account holder may alter how the payment is applied so that the account holder knows he/she is in effect “overpaying” the amount due under that credit limit for the current billing cycle.

Dynamic credit line management practices, including evaluation of account holders' (or prospective account holders′) credit-worthiness based on payments profiles as described herein, has mainly been discussed above in the context of setting two or more credit limits for the same credit card account. However, dynamic credit line management is not so limited, and may in some embodiments be applied to setting, increasing and/or reducing a general credit limit for a credit card account, including in situations where the general credit limit is the only applicable credit limit for the credit card account.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable.

As used herein and in the appended claims, the term “payment card system account” includes a credit card account, a deposit account that the account holder may access using a debit card, a prepaid card account, or any other type of account from which payment transactions may be consummated. The terms “payment card system account”, “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
establishing a credit account;
setting a credit limit for the credit account;
generating a payments profile for a holder of the credit account; and
adjusting the credit limit based on the payments profile.

2. The method of claim 1, wherein the payments profile includes at least one inference about the account holder's payment habits with respect to at least one service provider.

3. The method of claim 2, wherein said at least one service provider includes at least one of: (a) a landlord; (b) a day care provider; and (c) an elder care provider.

4. The method of claim 1, wherein the payment profile includes at least one inference about a life event of the account holder.

5. The method of claim 4, wherein the life event consists of one of (a) birth of a child; (b) relocation from one city to another; and (c) change of residence.

6. A method comprising:
establishing a credit account;
setting a first credit limit for the credit account, the first credit limit applicable to a first category of transactions; and
setting a second credit limit for the credit account, the second credit limit different from the first credit limit, the second credit limit applicable to a second category of transactions different from the first category of transactions.

7. The method of claim 6, wherein the first category of transactions consists of transactions with at least one selected category of merchants.

8. The method of claim 7, wherein the second category of transactions consists of all transactions not included in the first category of transactions.

9. The method of claim 7, wherein the first credit limit is higher than the second credit limit.

10. The method of claim 7, wherein the at least one selected category of merchants consists of two or more selected categories of merchants.

11. The method of claim 10, wherein the two or more selected categories of merchants consist of two or more of: (a) transit systems; (b) pharmacies; (c) groceries; and (d) gas stations.

12. The method of claim 7, further comprising:
receiving a request for an increase in the first credit limit.

13. The method of claim 12, further comprising:
automatically determining a response to the request by machine analysis of the request.

14. The method of claim 12, wherein the request does not include a request for an increase in the second credit limit.

15. The method of claim 14, wherein the second credit limit is lower than the first credit limit.

16. The method of claim 6, wherein the credit account is a credit card account.

17. A system comprising:
a processor; and
a memory in communication with the processor and storing program instructions, the processor operative with the program instructions to perform functions as follows:
establishing a credit account;
setting a first credit limit for the credit account, the first credit limit applicable to a first category of transactions; and
setting a second credit limit for the credit account, the second credit limit different from the first credit limit, the second credit limit applicable to a second category of transactions different from the first category of transactions.

18. The system of claim 17, wherein the first category of transactions consists of transactions with at least one selected category of merchants.

19. The system of claim 18, wherein the second category of transactions consists of all transactions not included in the first category of transactions.

20. The system of claim 18, wherein the first credit limit is higher than the second credit limit.
